(19) United States
(12) Patent Application Publication
(10) Pub. No.: US 2024/0260630 A1
(43) Pub. Date: Aug. 8, 2024

(54) GLYCEROPHOSPHATE COMPOSITIONS FOR IMPROVING FLAVOR IN CONSUMABLE PRODUCTS

(71) Applicant: NutriScience Innovations LLC, Milford, CT (US)

(72) Inventor: David Bom, Union, KY (US)

(21) Appl. No.: 18/409,973

(22) Filed: Jan. 11, 2024

Related U.S. Application Data
(60) Provisional application No. 63/444,026, filed on Feb. 8, 2023.

(51) Int. Cl. A23L 27/00; A23L 27/20; A23L 27/40

(52) U.S. Cl. CPC A23L 27/84; A23L 27/202; A23L 27/45; A23L 27/86

(57) ABSTRACT

The present disclosure relates generally to glycerophosphate salts for use in multiple consumable products including food, beverages and supplements, to provide improved taste and mouthfeel characteristics to the consumable products. The present disclosure also relates to methods of utilizing various salts of glycerophosphate in a variety of consumable products including foods, beverages, pharmaceutical and nutraceutical formulations incorporating salts, such as potassium chloride or potassium citrate, wherein incorporation of the glycerophosphates improve the taste and palatability profiles of the consumable products.

### TECHNICAL FIELD

The present disclosure relates generally to glycerophosphate salts for use in various consumable products including food, beverages and supplements, to provide improved taste and mouthfeel characteristics to the consumable products. The present disclosure also relates to methods of utilizing various salts of glycerophosphate incorporated into a variety of consumable products including foods, beverages, pharmaceutical and nutraceutical formulations, all incorporating potassium chloride as an ingredient.

### BACKGROUND

Salts, such as potassium chloride and potassium citrate are commonly used ingredients in foods and beverages. They can serve as a sodium replacer in table salts and have a central role in hydration, and therefore are often incorporated into foods and beverages that support hydration. The problem with incorporating potassium chloride and/or potassium citrate for example, in a consumable product is that it gives the product a bitter metallic, astringent off taste or off flavor, which most consumers do not like.

Therefore, a need exists for an improved composition utilizing various salts of glycerophosphate to provide improved taste and mouthfeel characteristics to consumable products including foods, beverages, pharmaceutical and nutraceutical formulations incorporating salts such as potassium chloride and potassium citrate.

A need further exists for improved food products, including human and pet food, and beverages, e.g. sports hydration, rescue hydration, soups, bone broths, dairy products, pharmaceutical and nutraceutical formulations, whereby, a salt of glycerophosphate has been added to a food, beverage, pharmaceutical or nutraceutical product to mask or block the off notes and/or off tastes of salts like potassium chloride and potassium citrate.

A need further exists for an improved composition having one or more mineral glycerophosphate(s), which produces a mouthfeel enhancing effect in beverages, e.g. sports hydration, rescue hydration, soups, bone broths, dairy products, foods including pet food, pharmaceuticals, and nutraceuticals with a perceived improved viscosity/fullness in the oral cavity and throat.

The present disclosure describes the use of mineral glycerophosphates including sodium glycerophosphate, potassium glycerophosphate, magnesium glycerophosphate, calcium glycerophosphate or other salt forms, as a bitter masker, blocker and/or taste improver of the taste of salts or other substances with a bitter and/or astringent taste profile.

### SUMMARY

The present disclosure relates generally to a composition of glycerophosphate salts for use in multiple products including food, beverages and supplements, and methods of utilizing various salts of glycerophosphate into a variety of foods, beverages, pharmaceutical and nutraceutical formulations incorporating potassium chloride and/or potassium citrate.

In one embodiment, the present disclosure provides a consumable composition comprising mineral glycerophosphates incorporated into an orally consumable product for improving taste and palatability in the orally consumable product.

In another embodiment, the present disclosure provides a method for improving taste in a consumable product, the method comprising the steps of providing a consumable product containing potassium citrate, adding a mineral glycerophosphate to the consumable product, and, determining an improvement in taste and palatability of the consumable product.

In another embodiment, the present disclosure provides a method for improving taste in a consumable product, the method comprising the steps of providing a consumable product containing potassium chloride, adding a mineral glycerophosphate to the consumable product, and, determining an improvement in taste and palatability of the consumable product.

The present disclosure describes the improved mouthfeel/viscosity/fullness that is rendered to beverages, e.g. sports hydration, rescue hydration, soups, bone broths, dairy products, foods, including pet food, pharmaceuticals, and nutraceuticals through the addition of one or more mineral glycerophosphates. The enhancement of mouthfeel can render a food, including human food and pet food including, but not limited to, cat or dog food, more palatable. The mouthfeel enhancement conferred by these glycerophosphate salts can also provide the impression of higher sugar content by mimicking the mouthfeel of a carbohydrate-based sugar like, but not limited to, high fructose corn syrup (HFCS) or sucrose, enabling manufacturers to reduce the sugar in end products or to improve the taste perception of products containing natural and/or artificial sweeteners including, but not limited to, rebaudioside A, rebaudioside M, mogrosides, saccharine, ace-K, aspartame, sucralose, etc.

### DETAILED DESCRIPTION

The present disclosure is based on the unexpected characteristics of mineral glycerophosphates to block the bitter profile of potassium chloride, potassium citrate or other bitter or off tasting salts that may be present as a single ingredient or salt blend in a food, beverage, e.g. sports hydration, rescue hydration, soups, bone broths, dairy products, nutraceutical, or pharmaceutical product and/or provide a mouthfeel enhancement effect to a food, beverage, e.g. sports hydration, rescue hydration, soups, bone broths, dairy products, nutraceutical, or pharmaceutical product and/or provide a refreshing oral cooling effect. Thus, the present disclosure relates to the use of glycerophosphates to improve the taste, palatability, and mouthfeel of a variety of consumable products.

In the present disclosure, a hydration beverage or gel would incorporate one or more mineral glycerophosphates to simultaneously provide critical hydration components like sodium, potassium, calcium and/or magnesium, glycerol, and phosphorus, while also actively improving the taste profile of the product through the taste masking/bitter blocking of the mineral glycerophosphates being utilized, as well as improving the mouthfeel/viscosity of the solution.

A mineral glycerophosphate, e.g. sodium glycerophosphate, but not limited to sodium glycerophosphate, may be used alone or in combination with other mineral glycerophosphates, e.g. potassium glycerophosphate etc. to achieve the desired bitter blocking, masking, and/or taste improvement in a variety of consumable products. The bitter blocking, masking and taste improvement of the present compositions are unexpected, since glycerophosphates are cationic in structure. Additionally, sometimes a blend of bitter blockers and taste maskers may need to be used to completely mask the bitter and/or astringent profile of a food or beverage product. Under these circumstances, the mineral glycerophosphate(s) may be used in conjunction with other bitter blockers, taste maskers or FMPs (molecules or mixtures/extracts with Flavor Modifying Properties) as known to one skilled in the art.

### EXAMPLES

The following are examples of the use of various glycerophosphate salts to improve the taste profile (diminished off tastes, improved mouthfeel and oral cooling sensation) of aqueous solutions containing various bitter metallic salts:

### EXAMPLE 1 (CONTROL)—Potassium Chloride in Water Control

Procedure: Potassium chloride (334 mg) was dissolved in distilled water (118.3 ml) resulting in a clear solution. The taste of this solution was reported as bitter, metallic and astringent.

### EXAMPLE 2—Potassium Chloride in Water with Potassium Glycerophosphate

Procedure: Potassium chloride (301 mg) and potassium glycerophosphate (307 mg) was dissolved in distilled water (118.3 ml) resulting in a clear solution. The taste of this solution displayed good masking of the potassium chloride bitter metallic off note along with a reduction in overall astringency that was present in the example one control.

### EXAMPLE 3—Potassium Chloride in Water with Potassium Glycerophosphate

Procedure: Potassium chloride (271 mg) and potassium glycerophosphate (583 mg) was dissolved in distilled water (118.3 ml) resulting in a clear solution. The taste of this solution displayed good masking of the potassium chloride bitter metallic off note along with a reduction in overall astringency that was present in the example one control.

### EXAMPLE 4—Potassium Chloride in Water with Sodium Glycerophosphate

Procedure: Potassium chloride (334 mg) and sodium glycerophosphate (40 mg) was dissolved in distilled water (118.3 ml) resulting in a clear solution. The taste of this solution displayed very good masking of the potassium chloride bitter metallic off taste, while also adding mouthfeel/viscosity to the solution.

### EXAMPLE 5—Potassium Chloride in Water with Sodium Glycerophosphate

Procedure: Potassium chloride (334 mg) and sodium glycerophosphate (80 mg) was dissolved in distilled water (118.3 ml) resulting in a clear solution. The taste of this solution displayed very good masking of the potassium chloride bitter metallic off taste, while also adding mouthfeel/viscosity to the solution.

### EXAMPLE 6—Potassium Chloride in Water with Sodium Glycerophosphate

Procedure: Potassium chloride (334 mg) and sodium glycerophosphate (120 mg) was dissolved in distilled water (118.3 ml) resulting in a clear solution. The taste of this solution displayed very good masking of the potassium chloride bitter metallic off taste, while also adding mouthfeel/viscosity to the solution.

### EXAMPLE 7—Potassium Chloride in Water with Magnesium Glycerophosphate

Procedure: Potassium chloride (334 mg) and magnesium glycerophosphate (40 mg) was dissolved in distilled water (118.3 ml) resulting in a clear solution. The taste of this solution displayed very good masking of the potassium chloride bitter metallic off taste, while also adding mouthfeel/viscosity to the solution. This sample had a little astringency associated with it, but it did not detract from the overall taste profile of the sample.

### EXAMPLE 8—Potassium Chloride in Water with Magnesium Glycerophosphate

Procedure: Potassium chloride (334 mg) and magnesium glycerophosphate (80 mg) was dissolved in distilled water (118.3 ml) resulting in a clear solution. The taste of this solution displayed good masking of the potassium chloride bitter metallic off taste, while also adding mouthfeel/viscosity to the solution. This sample had a little astringency associated with it, but it did not detract from the overall taste profile of the sample.

### EXAMPLE 9—Potassium Chloride in Water with Magnesium Glycerophosphate

Procedure: Potassium chloride (334 mg) and magnesium glycerophosphate (120 mg) was dissolved in distilled water (118.3 ml) resulting in a clear solution. The taste of this solution displayed good masking of the potassium chloride bitter metallic off taste, while also adding mouthfeel/viscosity to the solution. This sample had a little astringency associated with it, but it did not detract from the overall taste profile of the sample.

### EXAMPLE 10—Potassium Chloride in Water with Calcium Glycerophosphate

Procedure: Potassium chloride (334 mg) and calcium glycerophosphate (40 mg) was dissolved in distilled water (118.3 ml) resulting in a clear solution. The taste of this solution displayed good masking of the potassium chloride bitter metallic off taste, while also adding mouthfeel/viscosity to the solution. This sample had a little astringency associated with it, but it did not detract from the overall taste profile of the sample.

### EXAMPLE 11—Potassium Chloride in Water with Calcium Glycerophosphate

Procedure: Potassium chloride (334 mg) and calcium glycerophosphate (80 mg) was dissolved in distilled water (118.3 ml) resulting in a clear solution. The taste of this solution displayed good masking of the potassium chloride bitter metallic off taste, while also adding mouthfeel/viscosity to the solution. This sample had a little astringency associated with it, but it did not detract from the overall taste profile of the sample.

### EXAMPLE 12—Potassium Chloride in Water with Calcium Glycerophosphate

Procedure: Potassium chloride (334 mg) and calcium glycerophosphate (120 mg) was dissolved in distilled water (118.3 ml) resulting in a clear solution. The taste of this solution displayed good masking of the potassium chloride bitter metallic off taste, while also adding mouthfeel/viscosity to the solution. This sample had a little more astringency associated with it, but it did not detract from the overall taste profile of the sample. It had a kind of milky taste at this level.

### EXAMPLE 13—Potassium Chloride in Water with Calcium Glycerophosphate

Procedure: Potassium chloride (334 mg) and calcium glycerophosphate (120 mg) was dissolved in distilled water (118.3 ml) resulting in a clear solution. The taste of this solution displayed good masking of the potassium chloride bitter metallic off taste, while also adding mouthfeel/viscosity to the solution. This sample had a little more astringency associated with it, but it did not detract from the overall taste profile of the sample. It had a kind of milky taste at this level.

### EXAMPLE 14 (CONTROL)—Potassium Citrate in Water Control

Procedure: Potassium citrate (492 mg) was dissolved in distilled water (118.3 ml) resulting in a clear solution. The taste of this solution was slightly briny.

### EXAMPLE 15—Potassium Citrate in Water with Potassium Glycerophosphate

Procedure: Potassium citrate (443 mg) and potassium glycerophosphate (452 mg) was dissolved in distilled water (118.3 ml) resulting in a clear solution. Aside from a slight astringent finish, the viscosity/mouthfeel of the sample was improved relative to the control.

### EXAMPLE 16—Potassium Citrate in Water with Potassium Glycerophosphate

Procedure: Potassium citrate (443 mg) and potassium glycerophosphate (858 mg) was dissolved in distilled water (118.3 ml) resulting in a clear solution. Aside from a slight astringent finish, the viscosity/mouthfeel of the sample was improved relative to the control.

### EXAMPLE 17—Potassium Citrate in Water with Potassium Glycerophosphate

Procedure: Potassium citrate (443 mg) and potassium glycerophosphate (1224 mg) was dissolved in distilled water (118.3 ml) resulting in a clear solution. Aside from a slight astringent finish, the viscosity/mouthfeel of the sample was improved relative to the control.

### EXAMPLE 18—Potassium Citrate in Water with Sodium Glycerophosphate

Procedure: Potassium citrate (443 mg) and sodium glycerophosphate (40 mg) was dissolved in distilled water (118.3 ml) resulting in a clear solution. Weak salty profile, but very clean taste.

### EXAMPLE 19—Potassium Citrate in Water with Sodium Glycerophosphate

Procedure: Potassium citrate (443 mg) and sodium glycerophosphate (80 mg) was dissolved in distilled water (118.3 ml) resulting in a clear solution. This solution had a little astringency with a boost in viscosity/mouthfeel.

### EXAMPLE 20—Potassium Citrate in Water with Sodium Glycerophosphate

Procedure: Potassium citrate (443 mg) and sodium glycerophosphate (120 mg) was dissolved in distilled water (118.3 ml) resulting in a clear solution. This solution had a little astringency with a boost in viscosity/mouthfeel and a slight briny character.

### EXAMPLE 21—Potassium Citrate in Water with Magnesium Glycerophosphate

Procedure: Potassium citrate (443 mg) and magnesium glycerophosphate (40 mg) was dissolved in distilled water (118.3 ml) resulting in a clear solution. This solution had a little astringency but was otherwise clean in taste.

### EXAMPLE 22—Potassium Citrate in Water with Magnesium Glycerophosphate

Procedure: Potassium citrate (443 mg) and magnesium glycerophosphate (80 mg) was dissolved in distilled water (118.3 ml) resulting in a clear solution. This solution had a little astringency, but otherwise clean.

### EXAMPLE 23—Potassium Citrate in Water with Magnesium Glycerophosphate

Procedure: Potassium citrate (443 mg) and magnesium glycerophosphate (120 mg) was dissolved in distilled water (118.3 ml) resulting in a clear solution. This solution had a little astringency and a viscous, full mouthfeel.

### EXAMPLE 24—Potassium Citrate in Water with Calcium Glycerophosphate

Procedure: Potassium citrate (443 mg) and calcium glycerophosphate (40 mg) was dissolved in distilled water (118.3 ml) resulting in a clear solution. This solution had a little astringency but tasted clean overall.

### EXAMPLE 25—Potassium Citrate in Water with Calcium Glycerophosphate

Procedure: Potassium citrate (443 mg) and calcium glycerophosphate (80 mg) was dissolved in distilled water (118.3 ml) resulting in a clear solution. This solution had a little astringency with a slight briny/milky/viscous/mouthfeel.

### EXAMPLE 26—Potassium Citrate in Water with Calcium Glycerophosphate

Procedure: Potassium citrate (443 mg) and calcium glycerophosphate (120 mg) was dissolved in distilled water (118.3 ml) resulting in a clear solution. This solution had a little astringency with a briny/milky/viscous/mouthfeel.

### EXAMPLE 27—Dipotassium Phosphate in Water Control

Procedure: Dipotassium phosphate (389 mg) was dissolved in distilled water (118.3 ml) resulting in a clear solution. This solution had a little astringency with a slight bitter metallic taste.

### EXAMPLE 28—Dipotassium Phosphate in Water with Potassium Glycerophosphate

Procedure: Dipotassium phosphate (350 mg) and potassium glycerophosphate (357 mg) was dissolved in distilled water (118.3 ml) resulting in a clear solution. This solution had a little astringency with a slight bitter metallic taste and a more viscous mouthfeel/fullness relative to the control.

### EXAMPLE 29—Dipotassium Phosphate in Water with Potassium Glycerophosphate

Procedure: Dipotassium phosphate (315 mg) and potassium glycerophosphate (678 mg) was dissolved in distilled water (118.3 ml) resulting in a clear solution. This solution had less astringency, the bitter metallic taste was masked, there was an oral cooling sensation and it had a more viscous mouthfeel/fullness relative to the control.

### EXAMPLE 30—Dipotassium Phosphate in Water with Potassium Glycerophosphate

Procedure: Dipotassium phosphate (283 mg) and potassium glycerophosphate (967 mg) was dissolved in distilled water (118.3 ml) resulting in a clear solution. This solution had less astringency, the bitter metallic taste was masked, there was an intense oral cooling sensation and it had a more viscous mouthfeel/fullness relative to the control.

### EXAMPLE 31—Dipotassium Phosphate in Water with Sodium Glycerophosphate

Procedure: Dipotassium phosphate (388 mg) and sodium glycerophosphate (40 mg) was dissolved in distilled water (118.3 ml) resulting in a clear solution. This solution was slightly astringent, slight bitter metallic taste and there was an intense oral cooling sensation.

### EXAMPLE 32—Dipotassium Phosphate in Water with Sodium Glycerophosphate

Procedure: Dipotassium phosphate (388 mg) and sodium glycerophosphate (80 mg) was dissolved in distilled water (118.3 ml) resulting in a clear solution. This solution was slightly astringent, the bitter metallic taste was masked, there was an intense oral cooling sensation and it had a more viscous mouthfeel/fullness relative to the control.

### EXAMPLE 33—Dipotassium Phosphate in Water with Sodium Glycerophosphate

Procedure: Dipotassium phosphate (388 mg) and sodium glycerophosphate (120 mg) was dissolved in distilled water (118.3 ml) resulting in a clear solution. This solution was slightly astringent, the bitter metallic taste was masked, there was an intense oral cooling sensation, and it had a more viscous mouthfeel/fullness relative to the control.

### EXAMPLE 34—Dipotassium Phosphate in Water with Magnesium Glycerophosphate

Procedure: Dipotassium phosphate (388 mg) and magnesium glycerophosphate (40 mg) was added to distilled water (118.3 ml) resulting in a turbid solution with a white undissolved solid. Surprisingly, magnesium glycerophosphate was not soluble in the presence of the dipotassium phosphate. This was true at the lowest amount of the magnesium glycerophosphate (40 mg) and only got worse as the amounts increased to 80 mg and 120 mg. Magnesium glycerophosphate does not work well with dipotassium phosphate.

### EXAMPLE 35—Dipotassium Phosphate in Water with Calcium Glycerophosphate

Procedure: Dipotassium phosphate (388 mg) and calcium glycerophosphate (40 mg) was added to distilled water (118.3 ml) resulting in a turbid solution with a white undissolved solid. Surprisingly, the calcium glycerophosphate was not soluble in the presence of the dipotassium phosphate. This was true at the lowest amount of the calcium glycerophosphate (40 mg) and only got worse as the amounts increased to 80 mg and 120 mg. Calcium glycerophosphate does not work well with dipotassium phosphate.

Applications for using the present composition of mineral glycerophosphate for enhanced mouthfeel and improved taste include incorporation of the composition in both salty and non-salty beverages, beverages with zero or low-calorie sweeteners which, generally, are perceived as “thin” and have poor mouthfeel, and stevia sweetened beverages, which tend to have a unique, lingering bitter, metallic and licorice after-taste. Enhanced viscosity/mouthfeel in food and beverages conveys the impression of higher full calorie sugars enabling manufacturers to reduce sugar content and improve the taste and consumer acceptance of their products. Enhanced viscosity in a product is also helpful to individuals that have difficulty swallowing.

1. A consumable composition comprising one or more mineral glycerophosphate(s) incorporated into an orally consumable product for improving taste and palatability in the orally consumable product.

2. The consumable composition of claim 1, wherein the orally consumable product contains potassium chloride.

3. The consumable composition of claim 2, wherein the mineral glycerophosphate(s) is/are capable of blocking a bitter taste profile of potassium chloride in the orally consumable product

4. The consumable composition of claim 1, wherein improving the taste in the consumable product includes reducing bitterness, reducing acidity, reducing astringency, reducing brininess, reducing saltiness, reducing metallic taste.

5. The consumable composition of claim 1, wherein the improvements in palatability in the consumable product include improving mouthfeel including increasing viscosity for fullness,

6. The consumable composition of claim 1, wherein the improvements in palatability in the consumable product include improving mouthfeel including providing a cooling sensation.

6. The consumable composition of claim 1, wherein the mineral glycerophosphate is selected from the group consisting of calcium glycerophosphate, sodium glycerophosphate, potassium glycerophosphate, and magnesium glycerophosphate.

7. The consumable composition of claim 1, wherein the orally consumable products include foods, beverages, supplements, pharmaceuticals and nutraceuticals.

8. The consumable composition of claim 7, wherein the orally consumable products include products for humans and animals.

9. A method for improving taste in a consumable product, the method comprising the steps of:
providing a consumable product containing potassium chloride;
adding a mineral glycerophosphate to the consumable product; and,
determining an improvement in taste and palatability of the consumable product.

10. The method of claim 9, wherein improving the taste of the consumable product includes reducing bitterness, reducing acidity, reducing astringency, reducing brininess, reducing saltiness, reducing metallic taste.

11. The method of claim 9, wherein the method further includes improving palatability in the consumable product including increasing viscosity for fullness.

12. The method of claim 9, wherein the method further includes improving palatability in the consumable including providing a cooling sensation.

13. The method of claim 9, wherein adding the mineral glycerophosphate to the consumable product blocks a bitter taste profile of the potassium chloride in the consumable product.

14. A method for improving taste in a consumable product, the method comprising the steps of:
providing a consumable product containing potassium citrate;
adding a mineral glycerophosphate to the consumable product; and,
determining an improvement in taste and palatability of the consumable product.

15. The method of claim 14, wherein adding the mineral glycerophosphate to the consumable product blocks a bitter taste profile of the potassium citrate in the consumable product.
